(19) United States
(12) Patent Application Publication
(10) Pub. No.: US 2007/0067179 A1
(43) Pub. Date: Mar. 22, 2007

(54) Framed art visualization software

(75) Inventors: Stephen Phillip Kerr, Everett, WA (US); David Michael Becker, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Wizard International, Inc., Mukilteo, WA (US)

(21) Appl. No.: 11/523,128

(22) Filed: Sep. 18, 2006

Related U.S. Application Data
(60) Provisional application No. 60/717,717, filed on Sep. 16, 2005.

(51) Int. Cl. G06Q 99/00; G06F 17/00; G06G 7/00

(52) U.S. Cl. 705/1; 705/400

(57) ABSTRACT

Aspects of the present invention are directed at providing an application program that allows a user to select, model, and visualize components of a framed artwork. In accordance with one embodiment, a method is provided that allows a user to create a digitized representation of a framed artwork. More specifically, the method includes providing a user interface that includes controls for obtaining component selections of the framed artwork. Then, from the user interface, a set of component selections are received. As the component selections are received, the method renders the framed artwork for display.

### CROSS-REFERENCE TO RELATED APPLICATION

This application claims the benefit of U.S. Provisional Patent Application No. 60/717,717, filed Sep. 16, 2005, the benefit of which is hereby claimed under 35 U.S.C. § 119.

### FIELD OF THE INVENTION

The invention relates to software for selecting, modeling, and visualizing components of a framed artwork.

### BACKGROUND

Computing devices such as personal computing systems were originally developed for business applications such as word processing, spreadsheets, and databases, among others. Increasingly, computing devices are being used for tasks involving multimedia applications having video and audio components, video capture and playback, telephony applications, and speech recognition and synthesis. The advancements in hardware and software technology that enable computing devices to be used for these types of applications are generating additional technological advances in digital imaging devices such as video cameras, digital cameras, scanners, etc., that are used to capture digital images.

With the significant technological advances in computer technology, opportunities exist to automate previously labor-intensive and error-prone tasks. The process of framing artwork such as photographs, paintings, sketches, and other types of display works may involve selecting and configuring an array of desired products and other components. In this regard, a framed artwork may be comprised of artworks, mats, moldings, fillets, among other components. Moreover, at least some of the components included in a framed artwork may have different attributes (size, texture, and the like). For example, a mat that is commonly used as a border for framing an artwork may be manufactured in a variety of sizes and textures. Typically, a piece of framed artwork is designed manually with users gathering knowledge of makes, models, types, features, of the components that may be included in the framed artwork. Once the components have been selected, the user makes a number of design choices when assembling the components.

A major deficiency with respect to traditional systems for creating a framed artwork stems from the fact that the components available to the user are not static. For example, the inventory of components that may be purchased from a retail outlet is constantly changing as components in various styles and from different manufacturers are received and purchased. As a result, gathering knowledge of the different makes, models, types, and features of the components available to the user is labor intensive.

Another deficiency with traditional systems is that a user may be unable to view a representation of the framed artwork before the components are assembled. In this regard, a user makes a number of component and design choices when creating a framed artwork. However, it may be difficult or impossible to visualize the interactions between the components or the general layout of the framed artwork. As a result, a user may be dissatisfied with a final product when the framed artwork is assembled.

Increasingly, machines are being used to customize the components of a framed artwork. By way of example only, a mat selected as the border in the framed artwork may be customized in a way that depends on design choices made by a user. In this regard, a machine may be used to cut openings, windows, and/or decorative carvings into a stock mat. However, the data used to customize the components of a framed artwork may not be accurately obtained using conventional techniques or may only be obtained through a labor-intensive and time-consuming process. Thus, another limitation with respect to prior methods of designing and assembling a framed artwork relates to accurately obtaining and providing data to systems that may be used to customize component parts.

The foregoing deficiencies in traditional systems for creating a framed artwork have been overcome by the present invention that involves a software system for selecting, modeling, and visualizing components of a framed artwork. Other objects and advantages of the invention will become apparent from the detailed description of the invention that follows.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present invention are directed at providing an application program that allows a user to select, model, and visualize components of a framed artwork. In accordance with one embodiment, a method is provided for creating a digitized representation of a framed artwork. More specifically, the method includes providing a user interface that includes controls for obtaining component selections of the framed artwork. Then, from the user interface, a set of component selections is made. As the component selections are made, the method renders a digitized representation of the framed artwork on a computer display.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial depiction of an exemplary computing environment in which aspects of the present invention may be implemented;

FIG. 2 is a block diagram of the computer illustrated in FIG. 1 with components for implementing aspects of the present invention;

FIG. 3 is a pictorial depiction a graphical user interface that may be used to obtain a set of component selections from the user in accordance with one embodiment;

FIGS. 4A-4C are pictorial depictions suitable to illustrate a user interface tool implemented in accordance with one embodiment of the present invention;

FIG. 5 is an exemplary flow diagram of a routine for creating a digitized representation of a framed artwork in accordance with one embodiment of the present invention; and

FIG. 6 is an exemplary flow diagram of a routine that renders a framed artwork for display to a user.

### DETAILED DESCRIPTION

The present invention may be described in the general context of computer-executable instructions, such as program modules, being executed by a computer. Generally described, program modules include routines, programs, widgets, objects, components, data structures, and the like that perform particular tasks or implement particular abstract data types. The present invention may also be practiced in distributed computing environments where tasks are performed by remote processing devices that are linked through a communications network. In a distributed computing environment, program modules may be located on local and/or remote computer storage media.

Although the present invention will be described primarily in the context of a software application used for selecting, modeling, and visualizing components of a framed artwork, those skilled in the art and others will appreciate the present invention is also applicable in other contexts. As used herein, the term artwork refers to any display work that is capable of being presented in a frame such as, but not limited to, photographs, paintings, memorabilia, crafts (e.g., needlepoint, quilts, etc.), sketches, prints, and the like. In any event, the following description first provides a general overview of a computing environment in which aspects of the present invention may be implemented. Then, exemplary user interfaces and routines that provide examples of how the present invention may be used in the context of creating a digitized representation of a framed artwork will be described. The examples provided herein are not intended to be exhaustive or to limit the invention to the precise forms disclosed. Similarly, any steps described herein may be interchangeable with other steps or combinations of steps in order to achieve the same result. Accordingly, the embodiments of the present invention described herein should be construed as illustrative in nature and not limiting.

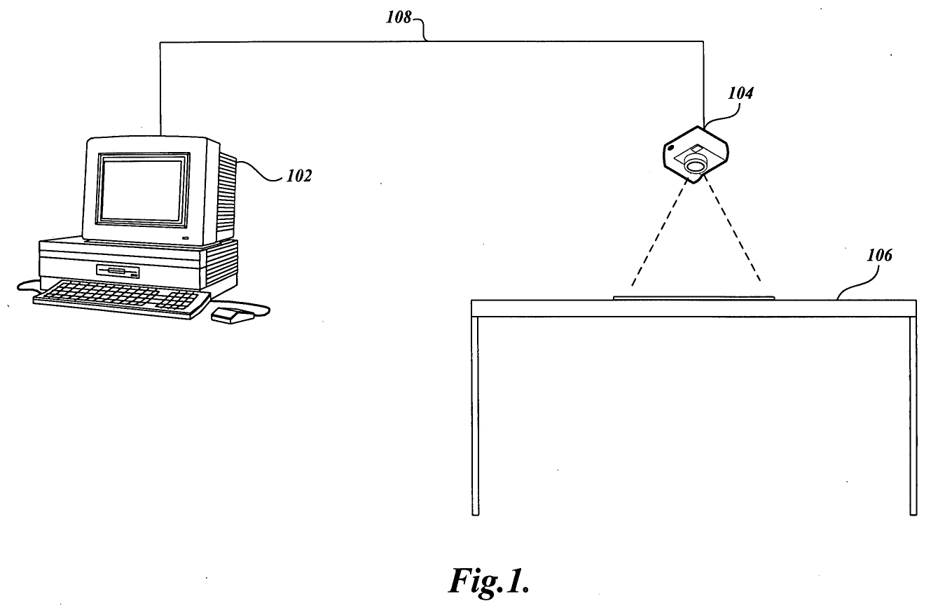

FIG. 1 and the following discussion are intended to provide a brief, general description of a computing environment 100 in which aspects of the present invention may be implemented. As illustrated in FIG. 1, the computing environment 100 is comprised of a computer 102, input device 104, and a workspace 106. Also, the computer 102 and input device 104 are communicatively connected via the direct communication link 108. It should be noted that, while the invention is generally described in terms of operating in conjunction with specific types of devices, this is for illustration purposes only and should not be construed as limiting. For example, while the computer 102 depicted in FIG. 1 is a personal computer, aspects of the present invention may be implemented in other types of computers such as, but not limited to, tablet computers, notebook computers, server computers, and the like.

There are numerous contexts in which the present invention may be implemented, of which the following are only examples. For instance, the input device 104 may be a digital camera that is capable of capturing a digital representation of an artwork placed on the workspace 106. When captured, an image of the artwork is transmitted from the digital camera to the computer 102 via the direct communication link 108. Framed art visualization software implemented by the present invention interfaces with the input device 104 so that image downloads may be controlled from the computer 102. More specifically, the framed art visualization software provides functionality that allows the user to acquire a real-time preview of data available to the input device 104 and capture a selected image. Once captured, an image may be displayed on a user interface or archived so that the image may be retrieved at a subsequent point in time.

Generally described, aspect of the present invention may be implemented in the computing environment 100 to capture an image of an artwork. Once captured, framed art visualization software that executes on the computer 102 may display the captured image on a user interface along with various interface controls for selecting, modeling, and visualizing components of the framed artwork. As a user interacts with the user interface, each selection made by the user is rendered for display on a computer monitor or similar output device. Moreover, by selecting between various templates or other software objects, a user is able to create a complete digitized representation of a framed artwork. This digitized representation allows the user to preview component selections and other design choices. Also, based on the selections made, the framed art visualization software may calculate attributes and instructions capable of being used by framing professionals, machines, and the like to assemble a finalized framed artwork. In this regard and by way of example only, the dimensions of an artwork may be calculated and instructions generated for cutting an opening into a stock mat that matches the artwork's calculated dimensions.

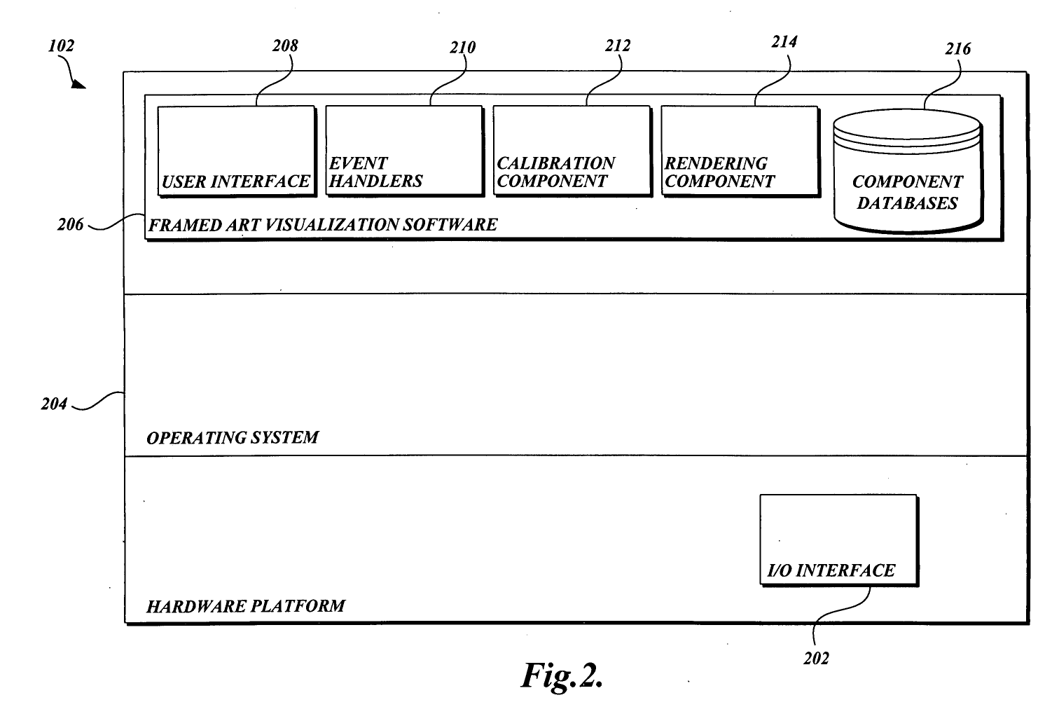

To provide a context for describing embodiments of the present invention, FIG. 2 illustrates a functional block diagram of the computer 102 depicted in FIG. 1. For ease of illustration and because they are not important for an understanding of the claimed subject matter, FIG. 2 does not show the typical components of many computers such as a CPU, a memory, a hard drive, a network interface card, a keyboard, a mouse, a printer, a display, etc. However, the computer 102 illustrated in FIG. 2 includes a hardware platform 200 with an I/O interface 202, an operating system 204, and framed art visualization software 206.

The I/O interface 202 enables the computer 102 to communicate with various local input and output devices. In this regard, I/O devices concurrently in communication with the I/O interface 202 may include computing elements that provide input signals to the computer 102, such as a video camera, digital camera, scanner, barcode reader, a keyboard, mouse, external memory, disk drive, etc. Moreover, output devices that may also be concurrently in communication with the I/O interface 202 could include typical output devices, such as a computer display (e.g., CRT or LCD screen), a television, printer, facsimile machine, copy machine, etc. As to the present invention, an output device allows the user to preview component selections and other design choices for a framed artwork that is created using the framed art visualization software 206.

The operating system 204 can be thought of as an interface between the application programs (e.g., the framed art visualization software 206) and the underlying hardware platform 200. The operating system 204 typically comprises various software routines that manage the physical components on the hardware platform 200 and their use by various application programs. For example, the computer 102 includes framed art visualization software 206 that may access physical components of the hardware platform 200 by interacting with the operating system 204.

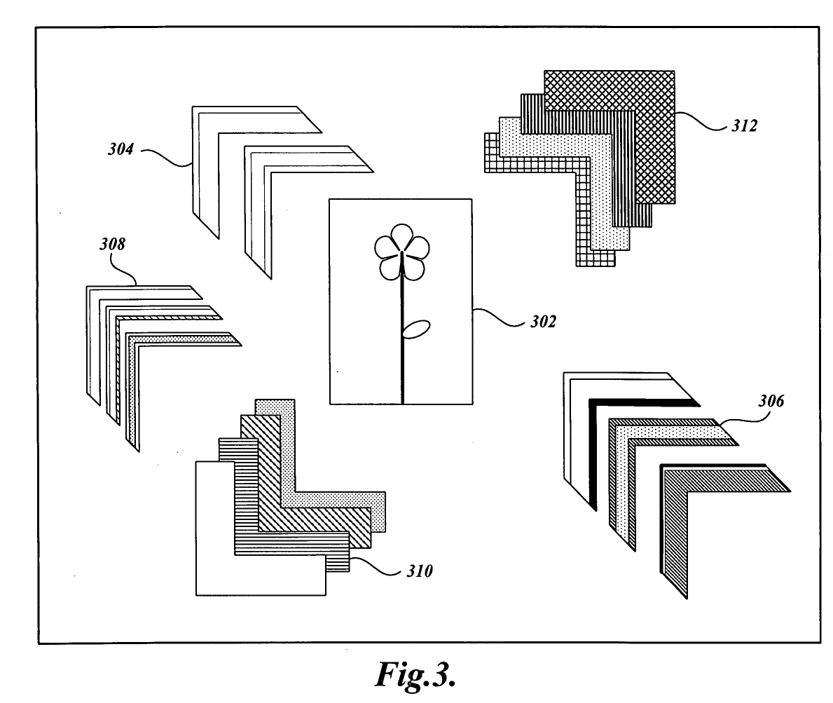

As illustrated in FIG. 2, the framed art visualization software 206 includes a user interface 208, a set of event handlers 210, a calibration component 212, a rendering component 214, and the component databases 216. Those skilled in the art and others will recognize that the user interface 208 is an I/O system typically characterized by the use of graphics on a computer display to interact and communicate with a computer user. In this regard, the user interface 208 is configured to, among other things, display a “palette” with interface controls that allow a user to create a digitized representation of a framed artwork. By interacting with the palette, a user may manipulate a captured image, select components (mats, moldings, fillets, etc.) for the framed artwork, and implement other design choices. An exemplary “palette” that may be presented to the user is described in further detail below with reference to FIG. 3.

When input is received from the user, the event handlers 210 process the received input so that the framed art visualization software 206 may produce the appropriate output. For example, the event handlers 210 receive different types of events directed at creating a digitized representation of a framed artwork. As these events are received, software objects that represent components of the framed artwork are manipulated to reflect the received input. In instances when a user selects, removes, or otherwise modifies the components of a framed artwork, the event handlers 210 may call the rendering component 214 so that an updated version of the framed artwork may be displayed. As described in further detail below, the rendering component 214 implements a layered rendering process that allows a digitized representation of a framed artwork to be displayed on an output device in a way that preserves the three-dimensional properties of the framed artwork.

When a framed artwork is being created, a user may select between components represented in the component databases 216. For example, a component database with images of moldings in different styles, textures, colors, may be accessed from the user interface 208. Similarly, component databases with images of mats, fillets, prints, and the like may also be accessed. Images of the various components may be captured and stored in the component databases 216 using conventional input devices such as digital cameras, flatbed scanners, and the like. In accordance with one embodiment, only those components that are available to the user may be accessed when the digitized version of the frame artwork is being created. For example, a barcode scanning system that obtains information about incoming shipments and outgoing purchases may be used to track a retail outlet's current inventory. In this embodiment, only those components that are “in stock” may be accessed from the component databases 216 provided by aspects of the present invention. In an actual embodiment, aspects of the present invention are integrated with point-of-sale pricing and invoicing software from which a framed artwork may be automatically priced and invoiced based on user selections. In addition to allowing framed artwork to be priced and invoiced automatically, this integration also allows the set of components that are available to be modified based on business information.

As illustrated in FIG. 2, the framed art visualization software 206 includes a calibration component 212. Generally described, the calibration component 212 accounts for variables in the user's computing environment so that the scale (e.g., size) of each captured artwork may be readily identified. As mentioned previously, aspects of the present invention may interface with a digital camera or other input device to capture images. However, the various input devices that may be used by the framed art visualization software 206 can have different attributes. For example, each make and model of a digital camera supports different “zoom” levels. Moreover, while the digital camera may be located a fixed distance from an artwork, this distance will typically vary depending on the configuration of a user's computing environment 100. To avoid requiring a user to manually measure the scale of each artwork, processing is performed by the calibration component 212 that enables scale information to be calculated automatically. More specifically, the calibration component 212 captures a set of control images of a “target” artwork that is of a known scale. In accordance with one embodiment, each of the images of the target artwork is taken at different zoom levels. The calibration component 212 processes the control images and plots the number of pixels per unit of measurement in each captured image against the zoom level at which the image was captured. Since the actual scale of the image on the “target” artwork is known, the plot of data created by the calibration component 212 provides a baseline from which scale information about any captured artwork may be derived.

As will be appreciated by those skilled in the art and others, FIG. 2 provides a simplified example of one computer 102 suitable for implementing aspects of the present invention. In other embodiments, the functions and features of the computer shown may be implemented using additional or different components. Moreover, while the components that implement aspects of the present invention are illustrated in FIG. 2 as being maintained on a single computer, this is for illustrative purposes only. For example, the functionality of any of the components of the framed artwork visualization software 206, e.g., the user interface 208, the event handlers 210, the calibration component 212, the rendering component 214, and the component databases 216 may be located on remote computing devices and executed in a distributed computing environment where tasks are performed by remote processing devices that are linked through a communications network. In a distributed computing environment, program modules may be located on local and/or remote computer storage media.

For illustrative purposes and by way of example only, an exemplary palette 300 suitable to obtain input from a user is illustrated in FIG. 3. As mentioned previously, a user interface with readily understandable controls may be utilized to interact with a user. In this regard, the palette 300 illustrated in FIG. 3 is one aspect of the user interface that may be employed by aspects of the present invention. The palette 300 illustrated in FIG. 3 includes a captured image 302, a first set of molding templates 304, a second set of molding templates 306, a set of fillet templates 308, a first set of mat templates 310, and a second set of mat templates 312.

As used herein, visualization generally refers to computer systems provided by the present invention that allow a user to view an existing layout of a framed artwork. By interacting with the palette 300, a user is able to visualize the layout of a framed artwork as component selections are made. For example, from the palette 300, a user may employ an input device (e.g., mouse) to select a particular style of molding displayed in the molding templates 304-306. Similarly, fillets and mats may be selected from the set of fillet templates 308 and mat templates 310-312, respectively. As a user makes selections from the palette 300, the selected components are displaced at their appropriate locations in relation to captured image 302. In this way, a user is able to visualize the inter-connections between components of a framed artwork.

As used herein, modeling generally refers to computer systems provided by the present invention that allow a user to design a framed artwork. In this regard, a user arranges component selections on the palette 300 and connects the components together in some manner. For example, a framed artwork may contain one or more mats that are selected from the first and second mat templates 310-312. Controls accessible from the palette 300 allow the user to define the number, size, and arrangement of the selected mats. Moreover, as described in further detail below, a user may define other design semantics of the framed artwork that relate to the attributes and relationships between components. While FIG. 3 depicts a palette 300 with certain components being displayed, those skilled in the art and others will recognize the components displayed on the palette are exemplary.

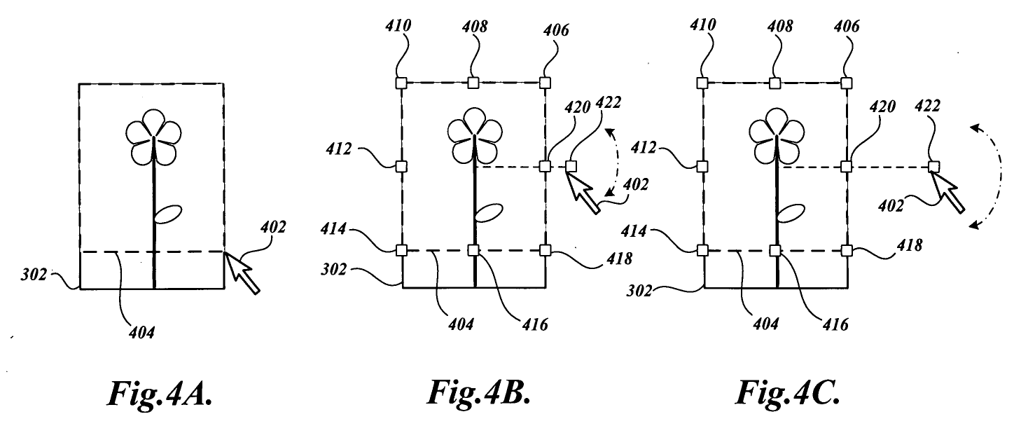

Now with reference to FIGS. 4A-4C, a user interface tool capable of correcting skew in a captured image will be described. In some instances, the orientation of an image that is captured using conventional input devices is skewed. In this regard, FIG. 4A depicts the captured image 302 described above with reference to FIG. 3. Those skilled in the art and others will recognize that a certain amount of skew in a captured image is common. In accordance with one embodiment, a user may employ an input device (e.g., mouse) to select all or a portion of a captured image 302. For example, as depicted in FIG. 4A, a user may employ an input device to move the pointer 402 and select a portion of the captured image 302 identified by the selection box 404. The selection box 404 may be created using a technique known as “drag-and-drop” in which a user generates pointer selection events (e.g., mouse clicks) while moving the pointer 402 across a computer display. In any event, once at least a portion of the captured image 302 has been selected, a tool that is well suited for manipulating images in the context of the assembling a framed artwork is available. As described in further detail below, this tool may be used to rotate an image in very fine degrees of granularity. Moreover, the tool may be used to “crop” the selected portion of an image without a user being required to select another tool.

Once the selection box 400 has been created, GUI elements are displayed that indicate the tool for correcting skew is available. As illustrated in FIG. 4B, these GUI elements include the handles 406-422 that each may be selected by the user. In this regard and in accordance with one embodiment, when the handle 422 is selected, the user may generate pointer movement that rotates the selection box 400 and the associated captured image 302. For example, as depicted in FIG. 4B, by selecting the handle 422 the user may rotate the selection box 400 in either the clockwise or counterclockwise directions.

The user interface tool that is available when an image is selected provides a way to employ a very fine degree of granularity in rotating a selected image. As depicted in FIG. 4C, by employing the same “drag-and-drop” technique described above, a user may select and move the handle 422 away from the selection box 400 to increase the radius from which the image 302 may be rotated. Stated differently, when the handle 422 is moved away from the selection box 400, a proportionally greater amount of rotational pointer movement is required to rotate the image 302.

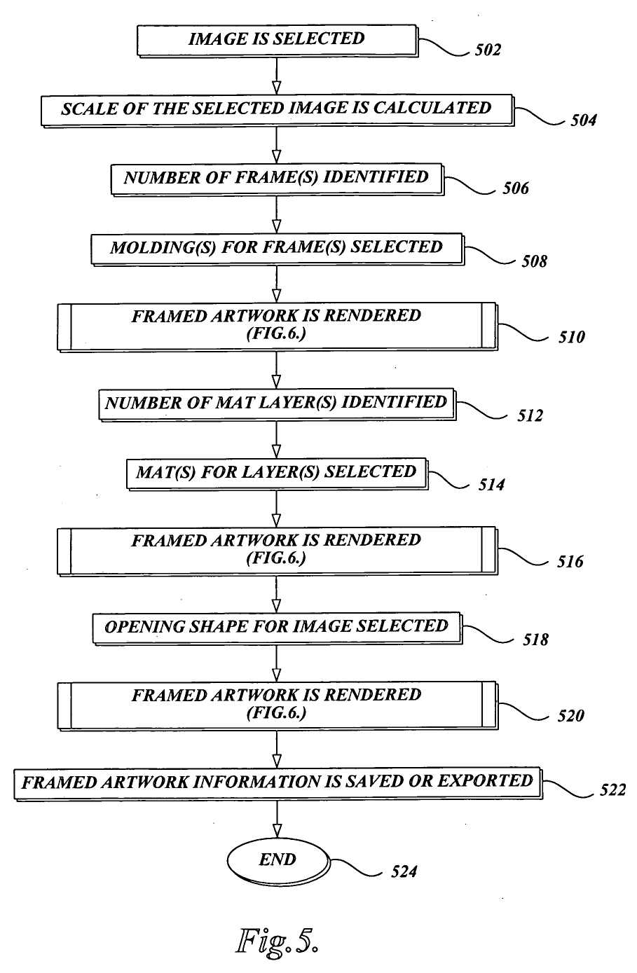

Now with reference to FIG. 5, an exemplary assembly routine 500 that may be used to assemble a digitized representation of a framed artwork capable of being visualized and modeled in a computer will be described. As a preliminary matter, the assembly routine 500 described below with reference to FIG. 5 provides an exemplary series of steps for assembling a framed artwork. However, as mentioned previously and in accordance with one embodiment, the framed art visualization software 206 implemented by aspects of the present invention is event driven. As a result, the steps described below are merely exemplary and may be performed in a different order than described. Moreover, those skilled in the art and others will recognize that additional or fewer steps may be performed to assemble a framed artwork.

As illustrated in FIG. 5, at block 502, one or more images are selected as the focus of a framed artwork that is being created. As described previously and in accordance with one embodiment, a user may capture an image using a digital camera or similar input device. In other embodiments, an image accessible from a mass storage device (e.g., hard drive), removable drives (floppy, CD-ROM, DVD-ROM, etc.), network locations, and the like may also be selected, at block 502. The image selected at block 502 may be in any number of different digital formats such as, but not limited to, JPEG, Bitmap, TIFF, RAW, etc. Moreover, using techniques described above with reference to FIGS. 4A-4C, a user may employ a user interface tool provided by the present invention to rotate the selected image, crop the image, and the like. Moreover, the user interface tool may be used to select more than one image as the focus of the framed artwork. For example, the user interface tool may be used to select and move a portion of a captured image to create a montage consisting of multiple images from related subject matter. In this regard, it should be well understood that aspects of the present invention are configured to create framed artwork with multiple images and/or multiple openings. Moreover, a convenient user interface tool is provided so that the user may conveniently capture and select these multiple images from any number of different sources.

At block 504, the scale of an image selected at block 502 is calculated. In accordance with one embodiment, calibration information that accounts for variables in a computing environment is used to identify the scale of an image. Those skilled in the art and others will recognize that pixels are the basic units of data used to represent images. When an image is captured using a digital camera or similar input device, the image consists of a known number of pixels (e.g., 640×480). As mentioned previously, the calibration component 212 processes a set of control images to identify the number of pixels per unit of measurement for various zoom levels at which each control image was captured. This calibration information provides a baseline from which scale information for any captured image may be derived. More specifically, based on the zoom level at which an image is captured, the number of pixels per unit of measurement in the captured image may be identified using the data identified by the calibration component 212. Then, based on the number of pixels in the captured image, the scale of the artwork represented in the selected image may be readily calculated by performing arithmetic operations generally known in the art.

At block 506, the number of frame(s) in the artwork being assembled is identified by the user. In this regard, a user may interact with a pop-up box, menu item, or other GUI element accessible from the palette 300 to identify the number of frame(s) in the framed artwork being assembled.

In this illustrative embodiment, a user selects a molding(s) for the frame(s) of the artwork, at block 508. In one embodiment, a user may select a molding by employing an input device to identify a template presented on a user interface. For example, different styles of moldings that are available for selection may be presented to the user on the palette 300 (FIG. 3). However, in other embodiments, a user may access and/or select a molding based on manufacturer and/or molding name. In this regard and as mentioned previously, a component database is provided with information and images of moldings in different styles, textures, colors, etc. By interacting with a user interface provided by the present invention, information about moldings stored in the component database may be accessed.

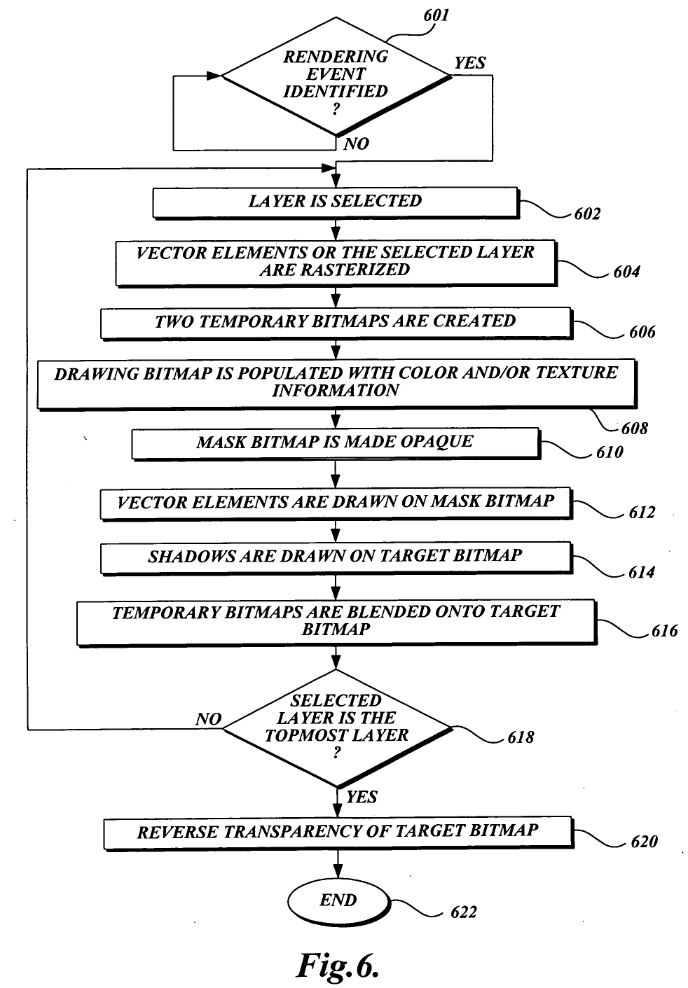

At block 510, a digitized representation of the framed artwork being assembled is rendered for display on a user interface. For example, in response to a particular molding being selected, at block 508 an image of the molding is added to the digitized representation of the framed artwork displayed on the palate 300. Since the process of rendering various components of the framed artwork for display is described below with reference to FIG. 6, the rendering process will not be described in detail here. However, it should be well understood that while moldings are presented externally to a user as images, a selected molding is represented internally as a software object. In this regard, a molding software object contains attribute information about a molding such as the molding's height, depth. width, profile, etc. These attributes model attributes of moldings that are used in conventional art design. As described in further detail below, the information associated with the molding software object maintained by the present invention is used to render the framed artwork, at block 510.

At block 512, the number of mat layer(s) in the artwork being assembled is identified by the user. Similar to the description provided above, a user may interact with a pop-up box, menu item, or other GUI element to provide input regarding the number of mat(s) that will be included in the framed artwork.

In this illustrative embodiment, a user selects a particular style of mat for the layer(s) of the framed artwork being assembled, at block 514. Similar to the description provided above with reference to block 510, a user may select a mat by employing an input device to identify an image presented on a user interface. However, in other embodiments, a user may access and/or select a mat based on manufacturer or other identification information. In this regard, a component database is provided with information and images of mats in different styles, textures, colors, and the like. By interacting with a user interface provided by the present invention, information about mats stored in a component database may be accessed.

At block 516, a digitized representation of a framed artwork with mat information is rendered for display on a user interface. For example, in response to a user selecting a mat, aspects of the present invention render the color and/or texture for the mat on the framed artwork being assembled. Since the process of rendering the components of a framed artwork for display to the user are described below with reference to FIG. 6, this process will not be described in detail here. However, similar to the description provided above, a mat is represented internally as a software object that maintains a set of attributes that model attributes of mat boards used in conventional art design.

As illustrated in FIG. 5, at block 518 the user selects an opening shape for the mat that borders an image in the framed artwork. As mentioned previously, an opening is made in a stock mat so that the mat may be used as a border. By interacting with a user interface provided by aspects of the present invention, an opening for a framed artwork that is in any number of different shapes and maintains various decorative aspects may be selected. Similar to the description provided above, a user may interact with a component database to select between various openings.

At block 520, a digitized representation of a framed artwork with the opening selected by the user is displayed on a user interface. Since the process of rendering various components of a framed artwork are described below with reference to FIG. 6, this process will not be described in detail here. However, an opening in a framed artwork is also represented internally by aspects of the present invention as a software object that models an opening in conventional art design. Moreover, an opening object may also contain instructions for cutting a stock mat, displaying the framed artwork, and the like.

At block 522, information that describes the framed artwork being assembled is saved or otherwise exported. For example, information that describes the state of a framed artwork may be saved in a file that is stored on a mass storage device (e.g., hard drive). This allows the user to recall saved projects for modification at a later point in time. Similarly, the information may be exported to one or more machines capable of making component parts of the framed artwork. Also, the information may be exported to other software modules such as point-of-sale pricing and invoicing software from which a framed artwork may be automatically priced and invoiced based on component selections made by a user. By way of another example, the information may be exported to a software module that serves as a viewer. In this regard, the viewer may be used to compare variations in different versions of a framed artwork that has different attributes and/or component selections. In accordance with one embodiment, attributes of a framed artwork may be defined and exported using the Extensible Markup Language (“XML”). However, it is to be appreciated that aspects of the present invention may use any language suitable for defining attributes of a framed artwork. Generally described, XML is a well known cross-platform, software, and hardware independent tool for transmitting information. Further, XML maintains its data as a hierarchically-structured tree of nodes, with each node comprising a tag that may contain descriptive attributes. XML is also well known for its ability to follow extendable patterns that may be dictated by the underlying data being described. Once the information that describes a framed artwork has been saved or otherwise exported as XML data, the assembly routine 500 proceeds to block 524, where it terminates.

The assembly routine 500 described with reference to FIG. 5 should be construed as exemplary as other component selections may be made when creating a framed artwork. For example, aspects of the present invention allow a user to add/remove VGrooves, fillets, float boards, and glazings for a framed artwork that is being assembled. Moreover, aspects of the present invention allow a user to define other attributes of the framed artwork. For example, a user may define a reveal value for each layer of the framed artwork being assembled that identifies the distance the layer extends into an opening. However, since these attributes may be obtained using similar techniques as those described above with reference to FIG. 5, these aspects of the present invention will not be described in further detail here.

As mentioned previously, a framed artwork may be rendered for display to a user in response to a component of a framed artwork being selected. For example, in response to a user selecting a particular molding, an image of the selected molding may be added to a framed artwork that is displayed on the palette 300. In accordance with one embodiment, aspects of the present invention implement a layering process to combine, manage, display, or otherwise visualize components of a framed artwork in a way that preserves three-dimensional aspects of a framed artwork.

Now with reference to FIG. 6, an exemplary rendering routine 600 will be described that performs processing so that components of a framed artwork may be rendered on an output device. As illustrated in FIG. 6, the rendering routine 600 begins at decision block 601 where the routine 600 remains idle until a rendering event is identified. For example, a rendering event may occur when a user selects a molding, mat, opening, VGroove, fillet, float board, glazing, or other component of a framed artwork. Also, a rendering event may occur when attributes of a component selection or other property of a framed artwork is defined.

In response to a rendering event, the lowest layer of a framed artwork that has not been rendered is selected, at block 602. In some systems, multi-layered images are rendered using a process that proceeds “top-down” through layers of the image. However, aspects of the present invention render an image of a framed artwork using a “bottom-up” rendering process. The inter-connections between the component selections make a bottom-up rendering process well suited for rendering the image of a framed artwork.

At block 604, vector elements of the selected layer are rasterized. Those skilled in the art and others will recognize that rasterization is the process of converting data into a matrix of pixels (e.g., bitmap) for display on an output device. During the rasterization process, various conversions may take place. In accordance with one embodiment, polygons that define a layer's vector elements are defined in order for the rendering routine 600 to rasterize the selected layer's vector elements, at block 604. The polygons consist of an array of screen coordinates that identifies endpoints of the lines that will be drawn.

At block 606, two temporary bitmaps for the selected layer are created. For each layer in an image, two temporary bitmaps are created that will be populated with different types of information. In accordance with one embodiment, a first temporary bitmap (hereinafter the “drawing bitmap”) stores drawing information for the selected layer. The second temporary bitmap (hereinafter the “mask bitmap”) stores transparency information about how the selected layer exposes elements from a lower layer. As described in further detail below, information in the two temporary bitmaps created a block 606 are blended together on a finalized bitmap that is displayed to the user (hereinafter the “target bitmap).” In any event, two temporary bitmaps for the selected layer are created at 606 and may be populated with different types of information, depending on the attributes of the selected layer.

At block 608, the drawing bitmap for the selected layer is filled with the appropriate color and/or texture information. As mentioned previously, a user may select colors and/or textures for components included in a framed artwork. This information is recalled, at block 608, so that the drawing bitmap may be filled. Then, at block 610, the mask bitmap for the selected layer is made opaque as a result of being filled with the color white. As used herein, the color white is used to make a bitmap opaque while the color black is used to make a bitmap transparent. As described in further detail below, if the layer selected at block 602 is the topmost layer in the image being rendered, the transparency of the target bitmap is set to the reverse of the mask bitmap.

At block 612, vector elements are drawn on the mask bitmap that is associated with the selected layer. As mentioned previously, polygons that consist of an array of screen coordinates define the vector elements to be drawn for the selected layer. In drawing the vector elements on the mask bitmap, the regions for the selected layer that expose a lower layer are defined.

As illustrated in FIG. 6, at block 614, shadows for the selected layer are drawn on the target bitmap that will be displayed to the user. As mentioned previously, aspects of the present invention render an image with three-dimensional aspects on a two-dimensional display. In this regard, shadows from one or more light sources may be defined. To render shadows that provide a three-dimensional effect, semi-transparent lines are drawn around the vector elements defined in the layer's polygons. These semi-transparent lines provide a shadowing effect so that components of the framed artwork may be represented as being three-dimensional. Then, at block 616, the two temporary bitmaps, namely, the drawing bitmap and the mask bitmap, are blended onto the target bitmap that will be displayed to the user.

As illustrated in FIG. 6, at decision block 618, a determination is made regarding whether the layer selected at block 602 is the topmost layer in the image of the framed artwork. This determination may be made by accessing data in software objects that define the components of the framed artwork. In any event, if the selected layer is not the topmost layer of the framed artwork, the rendering routine 600 proceeds back to block 602 and blocks 602 through 618 repeat until the topmost layer has been selected. Conversely, if the selected layer is the topmost layer, the rendering routine 600 proceeds to block 620 where the transparency of the target bitmap is set to be the reverse of the mask bitmap. As a result of reversing the transparency of the target bitmap in this way, the topmost layer in the image is presented as overlying elements in lower layers. However, certain elements in lower layers are presented to the user in a way that indicates the elements underlay a higher layer. Then, the rendering routine 600 proceeds to block 622, where it terminates.

Other components may be rendered for display by aspects of the present invention than those described above with reference to the rendering routine 600. For example, bevels that implement a three-dimensional effect by giving an image a raised appearance may be applied to components of the framed artwork. In this regard, bevels may be the drawn based on polygon information that defines a layer's vector elements. Moreover, fillets and moldings for the framed artwork may be rendered. However, since these components may be rendered without affecting the layering of an image, this aspect of the present invention will not be described in further detail here.

While illustrative embodiments have been illustrated and described, it will be appreciated that various changes can be made therein without departing from the spirit and scope of the invention.

1. In a computer that includes a hardware platform and an operating system for executing application programs, a method of creating a digitized representation of a framed artwork, the method comprising:
(a) providing a user interface with controls for obtaining component selections of the framed artwork;
(b) receiving a set of component selections from the user; and
(c) displaying the framed artwork on the user interface, wherein the framed artwork includes the components selected by the user.

2. The method as recited in claim 1, further comprising:
exporting data that describes the state of a framed artwork to point-of-sale software; and
calculating a price of the framed artwork.

3. The method as recited in claim 1, wherein the user interface further includes controls for modeling and visualizing the selected components of the framed artwork.

4. The method as recited in claim 1, wherein only those components that are available to the user for purchase from a retail outlet may be selected from the user interface.

5. The method as recited in claim 1, wherein providing a user interface with controls for obtaining component selections of the framed artwork, includes:
providing a user interface tool for rotating an image of the artwork; and
wherein the user interface tool allows the user to select the proportional amount of rotational pointer movement that is required to rotate the image.

6. The method as recited in claim 5, wherein the user interface tool allows the user to increase the radius from which the image is rotated so that a proportionally greater amount of rotational pointer movement is required to rotate the image by moving a GUI element away from a selection box.

7. The method as recited in claim 5, wherein the user interface tool is configured to rotate and crop a selected portion of the image without the user being required to select another user interface tool.

8. The method as recited in claim 1, wherein receiving a set of component selections from the user interface includes providing controls for selecting a frame, mat, and opening for the framed artwork.

9. The method as recited in claim 1, wherein receiving a set of component selections from the user interface includes providing controls for selecting a VGroove, fillet, and float board for the framed artwork.

10. The method as recited in claim 1, wherein displaying the framed artwork on the user interface includes exporting data that describes different versions of the framed artwork to a viewer for concurrent display to the user.

11. The method as recited in claim 1, wherein displaying the framed artwork on the user interface includes implementing a rendering process so that layers of the framed artwork may be visualized on an output device.

12. The method as recited in claim 11, wherein the rendering process is performed bottom-up with layers of the framed artwork farthest from the user being rendered before layers that are closer to the user.

13. The method as recited in claim 11, wherein implementing the rendering process, includes:
rasterizing vector elements of a selected layer;
creating a drawing bitmap and a mask bitmap, wherein the drawing bitmap is configured to store drawing information about the selected layer and the mask bitmap is configured to store transparency information about how the selected layer exposes elements from a lower layer;
populating the drawing bitmap and the mask bitmap with display information that depicts the component selections associated with the selected layer; and
blending the drawing bitmap and the mask bitmap to create a target bitmap.

14. The method as recited in claim 13, wherein populating the mask bitmap with display information that depicts the component selections associated with the selected layer includes drawing the vector elements associated with the selected layer on the mask bitmap.

15. The method as recited in claim 13, wherein populating the drawing bitmap with display information that depicts the component selections associated with the selected layer includes filling the drawing bitmap with color and texture information of a selected component.

16. The method as recited in claim 1, wherein the framed artwork displayed on the user interface may include one or more images that are each associated with a separate opening.

17. In a computing environment that includes a computer, an application program, and an input device configured to capture a digital representation of a target artwork, a method of calibrating the application program for use with the input device, the method comprising:
(a) capturing a set of control images of the target artwork, wherein the target artwork is of a known scale and the control images are captured at different zoom levels;
(b) identifying the number of pixels per unit of measurement in the control images; and
(c) quantifying calibration information that describes the number of pixels per unit of measurement in each control image against the zoom level at which each control image was captured.

18. The method as recited in claim 17, further comprising:
receiving an image selection of an actual artwork, wherein the scale of the actual artwork may not be known; and
using the calibration information to calculate the scale of the actual artwork.

19. The method as recited in claim 17, wherein the application program is configured to calculate scale information about any artwork captured in the computing environment.

20. The method. as recited in claim 17, wherein quantifying calibration information that describes the number of pixels per unit of measurement in each control image against the zoom level at which each image was captured includes generating a plot that provides a baseline from which the scale of a captured image may be obtained.

21. A computer-readable medium having computer executable components for creating a digitized representation of a framed artwork, comprising:
(a) an assembly component operative to:
(i) receive events directed at creating a digitized representation of a framed artwork;
(ii) modify software objects that represent components of the framed artwork to reflect the received events;
(b) a rendering component for causing a digitized representation of a framed artwork to be displayed on an output device; and
(c) a calibration component that accounts for variables in a computing environment so that scale information about an artwork can be calculated automatically.

22. The computer-readable medium as recited in claim 21, further comprising a user interface component that allows the user to visualize the layout of a framed artwork as component selections are made.

23. The computer-readable medium as recited in claim 21, wherein the user interface component includes a user interface tool for rotating the image; and
wherein the user interface tool includes an adjustable control for modifying the amount of pointer movement required to rotate the image.

24. The computer-readable medium as recited in claim 21, further comprising a point-of-sale component configured to price and invoice the framed artwork based on components selected by the user.
